(19) United States
(12) Patent Application Publication
(10) Pub. No.: US 2021/0366454 A1
(43) Pub. Date: Nov. 25, 2021

(54) SOUND SIGNAL SYNTHESIS METHOD, NEURAL NETWORK TRAINING METHOD, AND SOUND SYNTHESIZER

(71) Applicant: Yamaha Corporation, Hamamatsu (JP)

(72) Inventor: Ryunosuke DAIDO, Hamamatsu (JP)

(21) Appl. No.: 17/392,579

(22) Filed: Aug. 3, 2021

Related U.S. Application Data
(63) Continuation of application No. PCT/JP2020/003926, filed on Feb. 3, 2020.

(30) Foreign Application Priority Data
Feb. 6, 2019 (JP) 2019-019625
Feb. 20, 2019 (JP) 2019-028452

(51) Int. Cl. G10H 7/02; G10H 1/08

(52) U.S. Cl. CPC G10H 7/02; G10H 1/08; G10H 2250/211; G10H 2250/311; G10H 2250/481

(57) ABSTRACT

A sound signal synthesis method includes generating first data representing a deterministic component of a sound signal based on second control data representing conditions of the sound signal, generating, using a first generation model, second data representing a stochastic component of the sound signal based on the first data and first control data representing conditions of the sound signal, and combining the deterministic component represented by the first data and the stochastic component represented by the second data and thereby generating the sound signal.

### CROSS-REFERENCE TO RELATED APPLICATIONS

This application is a continuation application of International Application No. PCT/JP2020/003926, filed on Feb. 3, 2020, which claims priority to Japanese Patent Application No. 2019-019625 filed in Japan on Feb. 6, 2019 and Japanese Patent Application No. 2019-028452 filed in Japan on Feb. 20, 2019. The entire disclosures of International Application No, PCT/JP2020/003926 and Japanese Patent Application Nos. 2019-019625 and 2019-028452 are hereby incorporated herein by reference.

### BACKGROUND

### Technical Field

This disclosure relates to a technology for synthesizing sound signals.

### Background Information

For example, sounds such as voice, musical sounds, and the like usually contain components that are commonly included in each sound generated by a sound generator, when sound generation conditions such as pitch and tone are the same (hereinafter referred to as the “deterministic component”), as well as non-periodic components that change randomly for each generated sound (hereinafter referred to as the “stochastic component”). The stochastic component is generated due to stochastic factors in the process of sound generation. Examples of the stochastic components include components of the voice produced by turbulence in the air inside the human speech organ, components of musical sounds of bowed string instruments generated due to friction between the bow and the strings, etc.

Examples of sound generators that synthesize sound include additive synthesis that synthesizes sound by adding a plurality of sinusoidal waves, FM synthesis that synthesizes sound by FM modulation, and wave-table synthesis that reads recorded waveforms from a table to generate sound, modeling synthesis that synthesizes sound by modeling natural musical instruments and electric circuits, and the like. Although conventional sound generators can synthesize deterministic components of sound signals of high quality, no consideration is given to their reproduction of the stochastic components, and thus such sound generator cannot generate stochastic components of high quality. Although various noise sound generators as described in Japanese Laid-Open Patent Publication No. H4-77793 and Japanese Laid-Open Patent Publication No. H4-181996 have also been proposed, the reproducibility of the intensity distribution of the stochastic components is low, so that an improvement in the quality of generated sound signals is desired.

On the other hand, sound synthesis technology (hereinafter referred to as a “stochastic neural vocoder”) for using a neural network to generate sound waveforms in accordance with conditional inputs has been proposed, as in U.S. Patent Application Publication No. 2018/0322891. The stochastic neural vocoder estimates the probability density distribution for a sample of a sound signal, or parameters that represent it, at each time step. The final sound signal sample is set by generating a pseudo-random number corresponding to the estimated probability density distribution.

### SUMMARY

The stochastic neural vocoder can estimate the probability density distribution of stochastic components with high accuracy, and synthesize stochastic components of sound signals with relatively high quality, but it is not good at generating deterministic components with little noise. Therefore, deterministic components generated by the stochastic neural vocoder tend to be signals that contain noise. In consideration of such circumstances, an object of this disclosure is the synthesis of sound signals with high quality.

The sound signal synthesis method according to the present disclosure comprises generating first data representing a deterministic component of a sound signal based on second control data representing conditions of the sound signal, generating, using a first generation model, second data representing a stochastic component of the sound signal based on the first data and first control data representing conditions of the sound signal, and combining the deterministic component represented by the first data and the stochastic component represented by the second data and thereby generating the sound signal.

A neural network training method according to the present disclosure comprises acquiring a deterministic component of a reference signal, a stochastic component of the reference signal, and control data corresponding to the reference signal, and training a first neural network to estimate a probability density distribution of the stochastic component in accordance with the deterministic component and the control data.

### BRIEF DESCRIPTION OF THE DRAWINGS

FIG. 1 is a block diagram illustrating a hardware configuration of a sound synthesizer.

FIG. 2 is a block diagram illustrating a functional configuration of the sound synthesizer.

FIG. 3 is an explanatory diagram illustrating a temporal relation between control data and a sound signal.

FIG. 4 is an explanatory diagram for a processing of a first training module.

FIG. 5 is a flowchart of a processing of the first training module.

FIG. 6 is a flowchart of a preparation process.

FIG. 7 is an explanatory diagram of a processing of a first generation module.

FIG. 8 is a flowchart of a sound generation process.

FIG. 9 is a block diagram illustrating a functional configuration of a sound synthesizer according to a second embodiment.

FIG. 10 is an explanatory diagram for a processing of a second generation module according to a third embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

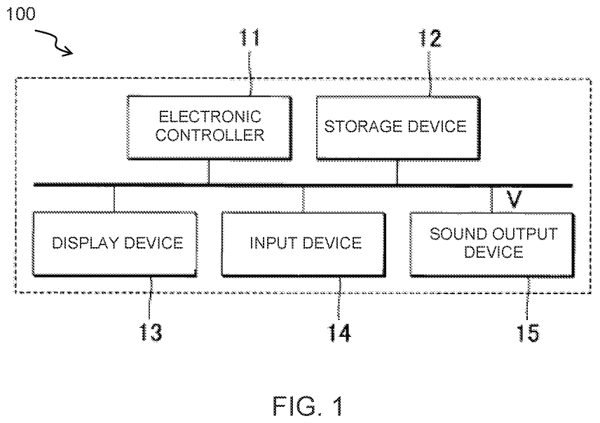

FIG. 1 is a block diagram illustrating the hardware configuration of a sound synthesizer 100. The sound synthesizer 100 is a computer system comprising an electronic controller (control device) 11, a storage device (computer memory) 12, a display device (display) 13, an input device (user operable input) 14, and a sound output device 15. The sound synthesizer 100 is an information terminal such as a mobile phone, a smartphone, or a personal computer.

The electronic controller 11 includes one or more processors and controls each element constituting the sound synthesizer 100. The term “electronic controller” as used herein refers to hardware that executes software programs. The electronic controller 11 is configured to comprise one or more processor types, such as a CPU (Central Processing Unit), an SPU (Sound Processing Unit), a DSP (Digital Signal Processor), an FPGA (Field Programmable Gate Array), an ASIC (Application Specific Integrated Circuit), etc. The electronic controller 11 generates a time-domain sound signal V that represents the synthesized sound waveform.

The storage device 12 includes one or more memory units for storing a program that is executed by the electronic controller 11 and various data that are used by the electronic controller 11. A known storage medium, such as a magnetic storage medium or a semiconductor storage medium, or a combination of a plurality of various types of storage media constitute the storage device 12. The storage device 12 can be any computer storage device or any computer readable medium with the sole exception of a transitory, propagating signal. Moreover, a storage device 12 that is separate from the sound synthesizer 100 (for example, cloud storage) can be prepared, and the electronic controller 11 can read from or write to the storage device 12 via a communication network, such as a mobile communication network or the Internet. That is, the storage device 12 can be omitted from the sound synthesizer 100.

The display device 13 displays the results of calculations executed by the electronic controller 11. The display device 13 is a liquid-crystal display panel, or an organic electroluminescent display, for example. The display device 13 can be omitted from the sound synthesizer 100.

The input device 14 receives inputs from a user. The input device 14 is a touch panel, a button, a switch, a lever, and/or a dial, for example. The input device 14 can be omitted from the sound synthesizer 100.

The sound output device 15 reproduces the sound represented by the sound signal V generated by the electronic controller 11. The sound output device 15 is a speaker and/or headphones, for example. Illustrations of a D/A converter that converts the sound signal V from digital to analog and of an amplifier that amplifies the sound signal V have been omitted for the sake of clarity. A configuration in which the sound synthesizer 100 is provided with the sound output device 15 is illustrated in FIG. 1; however, a sound output device 15 that is separate from the sound synthesizer 100 can be connected to the sound synthesizer 100 by wire or wirelessly.

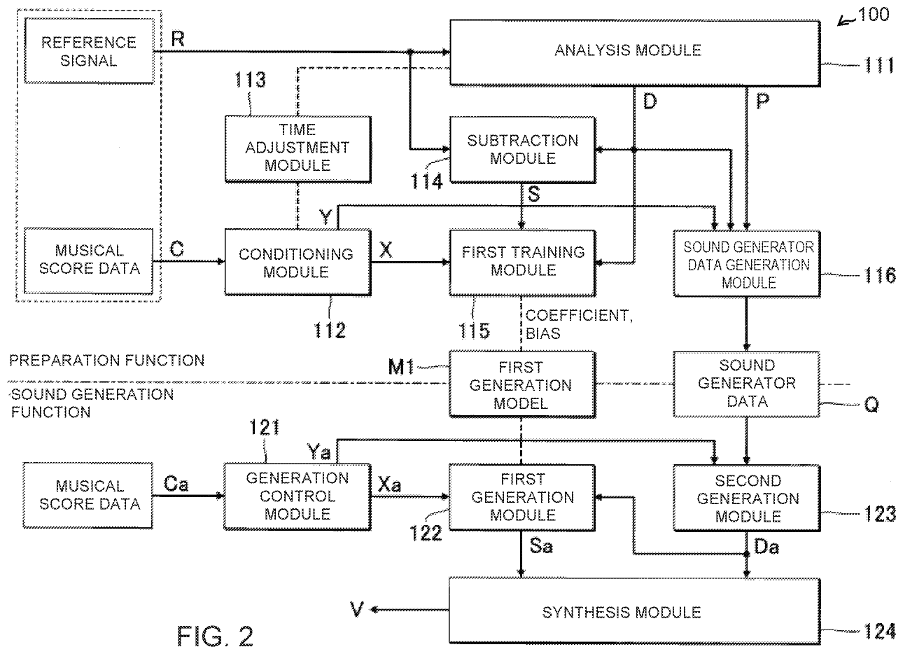

FIG. 2 is a block diagram illustrating the functional configuration of the sound synthesizer 100. The electronic controller 11 realizes a preparation function for preparing sound generator data Q and a first generation model M1 used for the generation of the sound signal V by the execution of a first program module that is stored in the storage device 12. More specifically, the electronic controller 11 executes a plurality of modules including an analysis module 111, a conditioning module 112, a time adjustment module 113, a subtraction module 114, a first training module (training module) 115, and a sound generator data generation module 116 to realize the preparation function. In addition, the electronic controller 11 realizes a sound generation function for generating the time-domain sound signal V representing a waveform of sound, such as a singing sound of a singer or a performing sound of a musical instrument, by the execution of a second program module including the sound generator data Q and the first generation model M1 that are stored in the storage device 12. More specifically, the electronic controller 11 executes a plurality of modules including a generation control module 121, a first generation module 122, a second generation module 123, and a synthesis module 124 to realize the sound generation function. The functions of the electronic controller 11 can be realized by a collection of a plurality of processing devices (that is, a system), or some or all of the functions of the electronic controller 11 can be realized by a dedicated electronic circuit (such as a signal processing circuit).

First, the first generation model M1 and the sound generator data Q will be described.

The first generation model M1 is a statistical model for generating a time series of a stochastic component Sa in the time domain in accordance with first control data Xa that specify (represent) conditions of the stochastic component Sa of the sound signal V to be synthesized. As described below in more detail, the first generation model M1 is a neural network (first neural network) that estimates second data that represent the stochastic component Sa, using the first control data and the first data as inputs. The characteristics of the first generation model M1 (specifically, the relationship between inputs and outputs) are defined by a plurality of variables (for example, coefficients, biases) that are stored in the storage device 12. The sound generator data Q are parameters applied to the generation of the deterministic component Da of the sound signal V.

The deterministic component Da, D (definitive component) is an acoustic component that is equally included in each sound generated by a sound generator, when sound generation conditions such as pitch and tone are the same. It can also be said that the deterministic component Da, D is an acoustic component that predominantly contains harmonic components (that is, periodic components) in comparison with the non-harmonic components. For example, the deterministic component Da, D is a periodic component derived from the regular vibrations of the vocal cords that produce speech. The stochastic component Sa, S (probability component), on the other hand, is a non-periodic acoustic component that is generated due to stochastic factors in the process of sound generation. For example, the stochastic component Sa, S includes a component of voice generated due to the turbulence of air inside the human speech organ, and/or a component of musical sounds of bowed string instruments generated due to friction between the bow and strings. It can also be said that the stochastic component Sa, S is an acoustic component that predominantly contains non-harmonic components in comparison with harmonic components. Further, it can also be said that the deterministic component Da, D can be expressed as a regular acoustic component that has periodicity, and that the stochastic component Sa, S can be expressed as an irregular acoustic component that is stochastically generated.

The first generation model M1 is a neural network for generating a probability density distribution of the stochastic components Sa. The probability density distribution can be expressed by a probability density value corresponding to each value of the stochastic component Sa, or by the mean and variance of the stochastic component Sa. The neural network can be a recursive type in which the probability density distribution of the current sample is estimated based on a plurality of past samples of a sound signal, such as WaveNet. In addition, the neural network can be a CNN (Convolutional Neural Network), RNN (Recurrent Neural Network), or a combination thereof. Furthermore, the neural network can be a type with additive elements such as LSTM (Long Short-Term Memory) or ATTENTION. The plurality of variables of the first generation model M1 are established by the preparation function that includes training using training data. The first generation model M1 for which the variables have been established is used for generating the stochastic component Sa of the sound signal V by the sound generation function described further below.

The sound generator data Q are used by the second generation module 123 to generate a time series of the deterministic component Da in accordance with second control data Ya, which specify conditions of the deterministic component Da of the sound signal V to be synthesized. The second generation module 123 generates the first data representing the deterministic component Da of the sound signal V based on the second control data Ya representing conditions of the sound signal. More specifically, the second generation module 123 is a sound generator that generates a time series of the deterministic component Da (one example of the first data) specified by the second control data Ya. The sound generator data Q are sound generator parameters that define, for example, the operation of the second generation module 123.

The method with which the second generation module 123 generates a time series of the deterministic component Da is arbitrary. The second generation module 123 is any one of additive synthesis, wavetable synthesis, FM synthesis, modeling synthesis, and concatenative synthesis. In this embodiment, additive synthesis is used as an example of the second generation module 123. The sound generator data Q applied to the additive synthesis are harmonic data that represent the loci of the frequency (or phase) and amplitude of the plurality of harmonic components included in the deterministic components Da. The harmonic data can be created based on the locus of each harmonic component of the deterministic component D included in the training data, or created based on the locus of each harmonic wave arbitrarily edited by a user.

The first generation model M1 estimates the probability density distribution of the stochastic component Sa(t) at time t on the basis of not only on the deterministic component Da(t) at time t, but also a plurality of deterministic components Da(t−k−1:t+m) from a time (t−k) before, to a time (t+m) after, time t. Here, k and m are arbitrary integers greater than or equal to 0 but that are not 0 at the same time. As described above, the symbol (t) is appended to the reference code of each element when attention is particularly focused on a specific time t, and the symbol (t) is omitted when referring to an arbitrary time t.

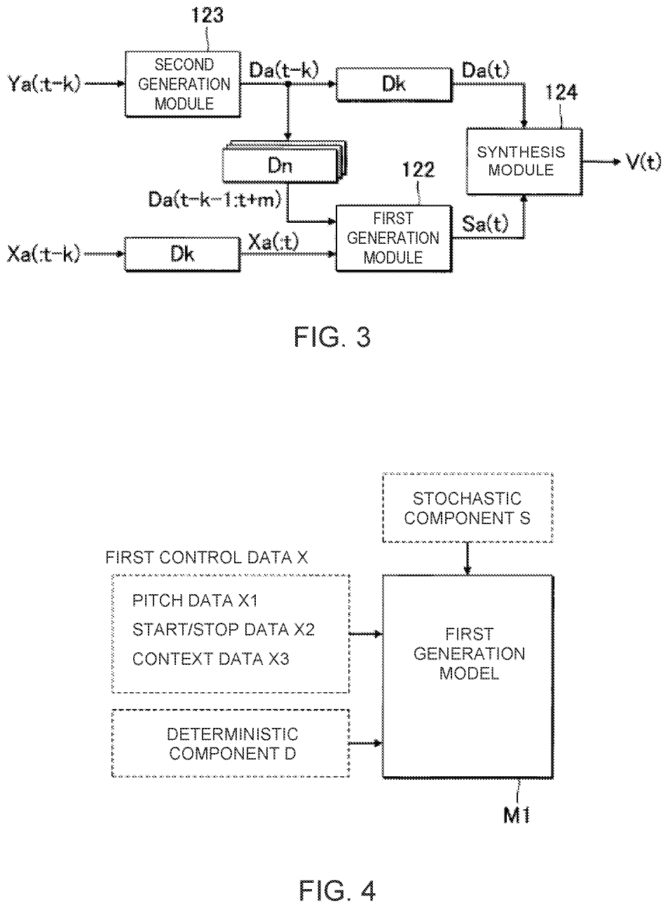

FIG. 3 is an explanatory diagram showing the time relation between the first control data Xa, the second control data Ya, the deterministic component Da, the stochastic component Sa, and the sound signal V. The second generation module 123 generates the deterministic component Da(t−k) of time (t−k) in accordance with the second control data Ya(:t−k) up to time (t−k), which is ahead of time t by k samples.

In FIG. 3, a process for adding a delay corresponding to k samples is illustrated by the symbol Dk. The first generation module 122 is supplied with the first control data Xa(:t) obtained by delaying the first control data Xa(:t−k) by k samples, and a plurality of the deterministic components Da(t−k−1:t+m) from time (t−k) to time (t+m). The plurality of deterministic components Da(t−k−1:t+m) are generated by delaying the deterministic component D(t−k) generated by the second generation module 123 by the number of samples corresponding to a variable n (n is a positive number from 0 to (k+m)). The first generation module 122 generates, using the first generation model M1, the second data representing the stochastic component Sa of the sound signal V based on the first data and the first control data Xa representing conditions of the sound signal V. More specifically, the first generation module 122 uses the first generation model M1 to generate the stochastic component Sa(t) at time t in accordance with the deterministic components Da(t−k−1:t+m) and the first control data Xa(t).

The synthesis module 124 combines the deterministic component Da represented by the first data arid the stochastic component Sa represented by the second data and thereby generates the sound signal V. More specifically, the synthesis module 124 adds the deterministic component Da(t) obtained by delaying the deterministic component Da(t−k) generated by the second generation module 123 by k samples and the stochastic component Sa(t) generated by the first generation module 122 and thereby synthesizes a sample V(t) at time t in the sound signal V. As explained above, the first generation model M1 estimates, at each time point in a series of time points, the second data based on a plurality of pieces of the first data at time points in a vicinity of each time point, and the first control data Xa. The first generation model M1 estimates the probability density distribution of the stochastic component Sa(t) at time t based on the first control data Xa(:t) up to time t and the plurality of deterministic components Da(t−k−1:t+m) in the vicinity of time t (from time (t−k) to time (t+m)).

As illustrated in FIG. 2, the storage device 12 stores a plurality of sets of musical score data C and reference signal R for training the first generation model M1. The musical score data C represent the musical score (that is, a time series of notes) of all or part of the musical piece. For example, time-series data specifying the pitch and pronunciation period for each note are utilized as the musical score data C. When singing sounds are synthesized, the musical score data C also specify the phonemes (for example, phonetic characters) for each note.

The reference signal R corresponding to each piece of the musical score data C represents the waveform of the sound generated by performing the musical score represented by the musical score data C. Specifically, the reference signal R represents a time series of partial waveforms corresponding to the time series of the notes represented by the musical score data C. Each reference signal R is formed of a time series of samples for each sampling period (for example, 48 kHz) and is a time-domain signal that represents a sound waveform including the deterministic component D and the stochastic component S. The performance for recording the reference signal R is not limited to the performance of a musical instrument by a human being, and can be a song sung by a singer or the automatic performance of a musical instrument. In order to generate the first generation model M1 that can generate a high-quality sound signal V by machine learning, a sufficient amount of training data is generally required. Accordingly, a large number of performance sound signals for a large number of musical instruments or performers are recorded in advance and stored in the storage device 12 as the reference signal R.

The preparation function will be described. The analysis module 111 calculates the deterministic component D from the time series of the spectrum in the frequency domain for each of the plurality of reference signals R respectively corresponding to a plurality musical scores. A known frequency analysis such as Discrete Fourier Transform is used for the calculation of the spectrum of the reference signal R. The analysis module 111 extracts the locus of the harmonic component from a time series of the spectrum of the reference signal R as a time series of the spectrum (hereinafter referred to as “deterministic spectrum”) P of the deterministic component D, and generates the deterministic component D of the time domain from the time series of the deterministic spectrum P.

The time adjustment module 113 adjusts the start time point and the end time point of each pronunciation unit in the musical score data C corresponding to each reference signal R to respectively match the start time point and the end time point of the partial waveform corresponding to the pronunciation unit in the reference signal R, based on a time series of the deterministic spectrum P. That is, the time adjustment module 113 specifies a partial waveform corresponding to each pronunciation unit of the reference signal R designated by the musical score data C. Here, the pronunciation unit is, for example, one note defined by the pitch and the pronunciation period. One note can be divided into a plurality of pronunciation units by dividing at time points at which a characteristics of the waveform, such as the tone, changes.

The conditioning module 112 generates, based on information of each pronunciation unit of the musical score data C in which time is arranged for each reference signal R, first control data X and second control data Y corresponding to each partial waveform of the reference signal R. The first control data X are output to the first training module 115, and the second control data Y are output to the sound generator data generation module 116. As illustrated in FIG. 4, the first control data X that specify conditions of the stochastic component S include, for example, pitch data X1, start/stop data (start and stop data) X2, and context data X3. The pitch data X1 specify the pitch of the partial waveform. The pitch data X1 can include changes in pitch caused by pitch bend or vibrato. The start/stop data X2 specify the start period (attack) and end period (release) of the partial waveform. The context data X3 specify the relationship with one or more pronunciation units before and after, such as the pitch difference with the notes before and after. The first control data X can further include other information, such as musical instruments, singers, playing styles, etc. When singing sounds are synthesized, the context data X3 specify the phoneme expressed by phonetic characters, for example. The second control data Y, which specify the conditions of the deterministic component D, specify at least the pitch of each pronunciation unit, the pronunciation start timing, and the decay start timing.

The subtraction module 114 of FIG. 2 generates the stochastic component S in the time domain by subtracting the deterministic component D of each reference signal R from each reference signal R. The deterministic spectrum P, the deterministic component D, and the stochastic component S of the reference signal R are obtained by the processing by each functional module up to this point.

Thus, training data (hereinafter refereed to as “unit data”) of the first generation model M1 are obtained for each pronunciation unit utilizing a plurality of sets of the reference signal R and the musical score data C. Each piece of unit data is a set of the first control data X, the deterministic component D, and the stochastic component S. Prior to training by the first training module 115, the plurality of pieces of the unit data are divided into training data for training the first generation model M1 and test data for testing the first generation model M1. Most of the plurality of pieces of the unit data are selected as the training data, and some are selected as the test data. With regard to the training by the training data, a plurality of pieces of training data are divided into batches for each prescribed number, and the batches are sequentially executed one by one for all of the batches. As can be understood from the foregoing explanation, the analysis module 111, the conditioning module 112, the time adjustment module 113, and the subtraction module 114 function as a preprocessing module for generating the plurality of pieces of training data.

The sound generator data generation module 116 uses the second control data Y and the deterministic component D to generate the sound generator data Q. Specifically, the sound generator data Q that define the operation of the second generation module 123 is generated, such that the second generation module 123 generates the deterministic component Da by supply of the second control data Ya. The deterministic spectrum P can be used for the generation of the sound generator data Q by the sound generator data generation module 116.

The first training module 115 acquires the deterministic component D of the reference signal R, the stochastic component S of the reference signal D, and the control data X corresponding to the reference signal R, and trains the neural network (first neural network, first generation model M1) such that the neural network becomes capable of estimating a probability density distribution of the stochastic component S in accordance with the deterministic component D and the control data X.

More specifically, the first training module 115 uses a plurality of pieces of training data to train the first generation model M1. Specifically, the first training module 115 receives a prescribed number of pieces of training data for each batch, and uses the deterministic component D, the stochastic component S, and the first control data X in each of the plurality of pieces of training data included in the batch to train the first generation model M1.

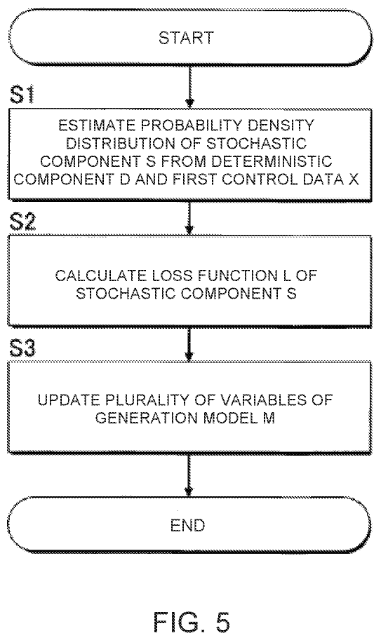

FIG. 4 is a diagram explaining the processing of the first training module 115, and FIG. 5 is a flowchart showing a specific procedure of the process executed by the first training module 115 for each batch. The deterministic component D and the stochastic component S of each pronunciation unit are generated from the same partial waveform.

The first training module 115 sequentially inputs the first control data X(t) and the plurality of deterministic component D(t−k−1:t+m) for each time t included in each piece of training data of one batch into the tentative first generation model M1 and thereby estimates the probability density distribution (one example of the second data) of the stochastic component S for each piece of training data (S1).

The first training module 115 calculates the loss function L of the stochastic component S (S2). The loss function L is a numerical value obtained by accumulating the loss function of the stochastic component S for the plurality of pieces of training data in a batch. The loss function of the stochastic component S is, for example, a numerical value obtained by inverting the sign of the logarithmic likelihood of the stochastic component S (that is, the correct answer value) in the training data, with respect to the probability density distribution of the stochastic component S estimated by the first generation model M1 from each piece of the training data. The first training module 115 updates the plurality of variables of the first generation model M1 such that the loss function L is decreased (S3).

The first training module 115 repeats the above-described training (S1-S3) that uses the prescribed number of pieces of training data of each batch until a prescribed termination condition is satisfied. The termination condition is, for example, the value of the loss function L calculated for the above-described test data becoming sufficiently small, or changes in the loss function L between successive trainings becoming sufficiently small.

The first generation model M1 established in this manner has learned the latent relationship between the first control data X, and the deterministic component D and the stochastic component S in the plurality of pieces of training data. By this sound generation function using the first generation model M1, a high-quality stochastic component Sa can be generated from the unknown first control data Xa and the deterministic component Da.

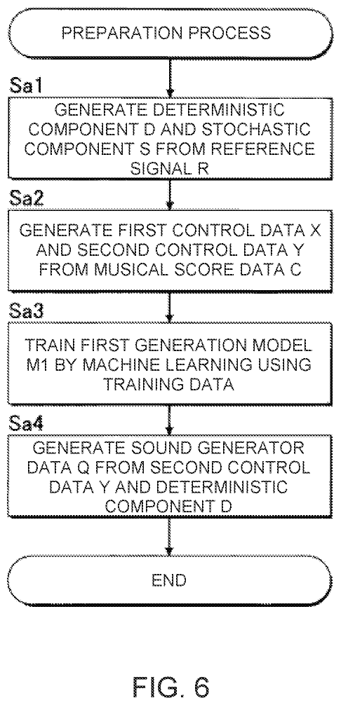

FIG. 6 is a flowchart of the preparation process. The preparation process is started, for example, in response to an instruction from a user of the sound synthesizer 100.

When the preparation process is started, the electronic controller 11 (the analysis module 111 and the subtraction module 114) generates the deterministic component D and the stochastic component S from each of the plurality of reference signals R (Sa1). The electronic controller 11 (the conditioning module 112 and the time adjustment module 113) generates the first control data X and the second control data Y from the musical score data C (Sa2). That is, training data including the first control data X, the deterministic component D, and the stochastic component S are generated for each partial waveform of the reference signal R. The electronic controller 11 (the first training module 115) trains the first generation model M1 by machine learning using the plurality of pieces of training data (Sa3). The specific procedure for training the first generation model M1 (Sa3) is as described above with reference to FIG. 4. Next, the electronic controller 11 (the sound generator data generation module 116) uses the second control data Y and the deterministic component D to generate the sound generator data Q (Sa4). The order of the training of the first generation model M1 (Sa3) and the generation of the sound generator data Q (Sa4) can be reversed.

The sound generation function for generating the sound signal V using the sound generator data Q and the first generation model M1 prepared by the preparation function will now be described. The sound generation function is a function for generating the sound signal V using musical score data Ca as input. The musical score data Ca are time-series data that specify the time series of notes that constitute all or part of the musical score, for example. When the sound signal V of singing sounds is synthesized, the phoneme for each note is designated by the musical score data Ca. The musical score data Ca represent a musical score edited by a user using the input device 14, while referring to an editing screen displayed on the display device 13, for example. The musical score data Ca received from an external device via a communication network can be used as well.

The generation control module 121 of FIG. 2 generates the first control data Xa and the second control data Ya based on the information on a series of pronunciation units of the musical score data Ca. The first control data Xa includes the pitch data X1, the start/stop data X2, and the context data X3 for each pronunciation unit specified by the musical score data Ca. As explained above, the pitch data X1 specify the pitch of the partial waveform. The pitch data X1 can include changes in pitch caused by pitch bend or vibrato. The start/stop data X2 specify the start period (attack) and end period (release) of the partial waveform. The context data X3 specify the relationship with one or more pronunciation units before and after, such as the pitch difference with the notes before and after. The first control data X can further include other information, such as musical instruments, singers, playing styles, etc. When singing sounds are synthesized, the context data X3 specify the phoneme expressed by phonetic characters, for example. The second control data Y, which specify the conditions of the deterministic component D, specify at least the pitch of each pronunciation unit, the pronunciation start timing, and the decay start timing. The first control data Xa can further include other information, such as musical instruments, singers, playing styles, etc. The second control data Ya are data that specify the conditions of the deterministic component D, and specify at least the pitch, the pronunciation start timing, and the decay start timing for each pronunciation unit.

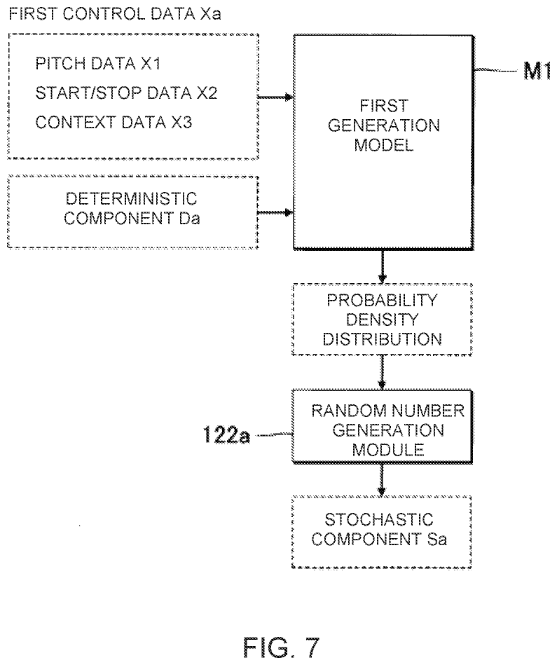

The first generation module 122 receives the deterministic component Da generated by the second generation module 123, described further below, and uses the first generation model M1 to generate the stochastic component Sa that is in accordance with the first control data Xa and the deterministic component Da. FIG. 7 is a diagram explaining the processing of the first generation module 122. The first generation module 122 uses the first generation model M1 to estimate the probability density distribution (one example of the second data) of the stochastic component Sa that is in accordance with the first control data Xa(t) and the plurality of deterministic components Da(t−k−1:t+m) for each sampling period (each time t).

The first generation module 122 includes a random number generation module (first random number generation module) 122a. The random number generation module 122a generates a random number (first random number) in accordance with the probability density distribution of the stochastic component Sa, and outputs the value as the stochastic component Sa (t) at that time t. The first generation module 122 inputs the deterministic components Da(t−k−1:t+m) corresponding to the time t into the first generation model M1 to generate the stochastic component Sa, so that the time series of the stochastic component Sa corresponds temporally to the time series of the deterministic component Da. That is, the deterministic component Da and the stochastic component Sa are samples at the same time point in the synthesized sound.

The second generation module 123 of FIG. 2 uses the sound generator data Q to generate the deterministic component Da (one example of the first data) corresponding to the second control data Ya. Specifically, the second generation module 123 refers to the sound generator data Q to generate the harmonic data corresponding to the pitch or tone specified by the second control data Ya. The second generation module 123 generates the deterministic component Da in the time domain by a prescribed calculation to which the harmonic data are applied. For example, the second generation module 123 adds a plurality of harmonic components represented by the harmonic data, thereby generating the deterministic component Da.

The synthesis module 124 combines the deterministic component Da and the stochastic component Sa, thereby synthesizing a time series of the samples of the sound signal V. For example, the synthesis module 124 adds the deterministic component Da and the stochastic component Sa, thereby synthesizing a time series of the samples of the sound signal V.

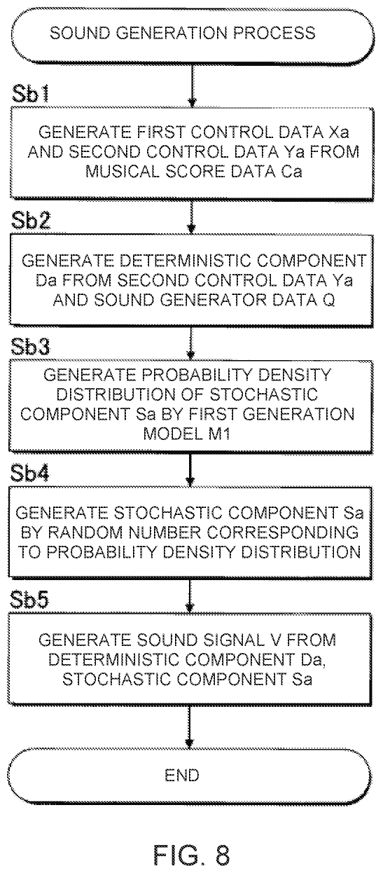

FIG. 8 is a flowchart of a process (hereinafter referred to as “sound generation process”) by which the electronic controller 11 generates the sound signal V from the musical score data Ca. The sound generation process is started, for example, in response to an instruction from a user of the sound synthesizer 100.

When the sound generation process is started, the electronic controller 11 (generation control module 121) generates the first control data Xa and the second control data Ya for each pronunciation unit from the musical score data Ca (Sb1). The electronic controller 11 (second generation module 123) generates the first data representing the deterministic component Da in accordance with the second control data Ya and the sound generator data Q (Sb2). The electronic controller 11 (first generation module 122) then, by using the first generation model M1, generates the second data representing the probability density distribution of the stochastic component Sa corresponding to the first control data Xa and the deterministic component Da (Sb3). The electronic controller 11 (first generation module 122) generates the stochastic component Sa in accordance with the probability density distribution of the stochastic component Sa (Sb4). More specifically, the electronic controller 11 (random number generation module 122a) generates a random number in accordance with the probability density distribution represented by the second data to generate the stochastic component Sa. The electronic controller 11 (synthesis module 124) combines the deterministic component Da and the stochastic component Sa, thereby generating the sound signal V (Sb5).

As described above, in the first embodiment, the deterministic component Da is generated in accordance with the second control data Ya representing the conditions of the sound signal V, and the stochastic component Sa is generated in accordance with the deterministic component Da and the first control data Xa representing the conditions of the sound signal V. Thus, the generation of a high-quality sound signal V is achieved. Specifically, for example, compared to the technology of Japanese Laid-Open Patent Publication No. H4-77793 or Japanese Laid-Open Patent Publication No. H4-181996, the high-quality sound signal V is generated, in which the intensity distribution of the stochastic component Sa is faithfully reproduced. In addition, compared to the stochastic neural vocoder of U.S. Patent Application Publication No. 2018/0322891, a deterministic component Da having few noise components is generated. That is, according to the first embodiment, both the deterministic component Da and the stochastic component Sa can generate the high-quality sound signal V.

### B: Second Embodiment

The second embodiment will be described. In each of the following embodiments, elements that have the same functions as in the first embodiment have been assigned the same reference symbols as those used to describe the first embodiment, and detailed descriptions thereof have been appropriately omitted.

In the first embodiment, an example was presented in which the second generation module 123 generates the deterministic component Da in accordance with the sound generator data Q, but the configuration for generating the deterministic component Da is not limited to the example described above. In the second embodiment, a second generation model M2 is used to generate the deterministic component Da. That is, the sound generator data Q of the first embodiment is replaced with the second generation model M2 in the second embodiment.

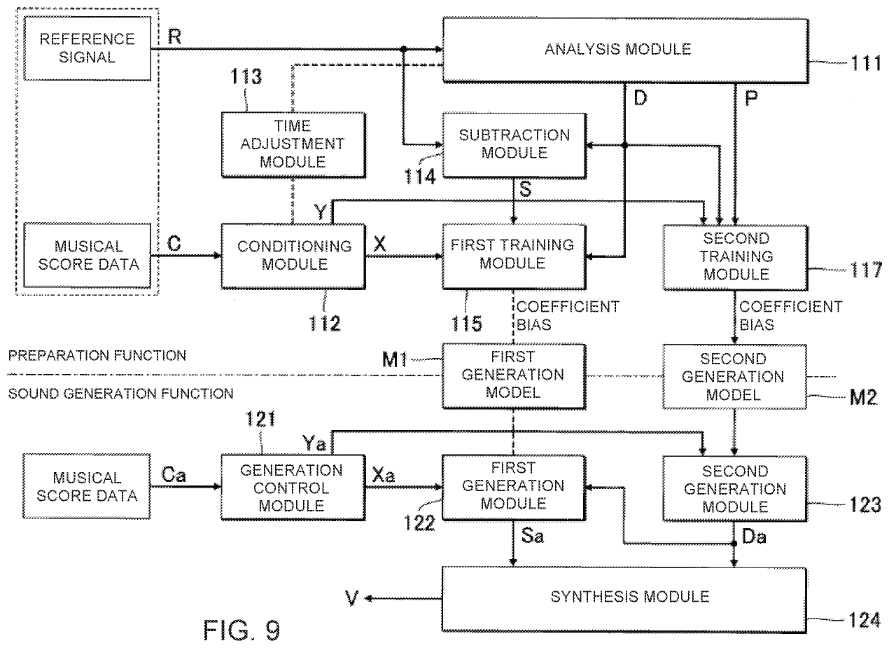

FIG. 9 is a block diagram illustrating the functional configuration of the sound synthesizer 100. In place of the sound generator data generation module 116 of the first embodiment, the sound synthesizer 100 of the second embodiment has a second training module 117 that trains the second generation model M2. The second generation model M2 is a statistical model for generating the deterministic component Da of the sound signal V in accordance with the second control data Ya that specify conditions of the sound signal V. The characteristics of the second generation model M2 (specifically, the relationship between input and output) are defined by a plurality of variables (for example, coefficients, biases) that are stored in the storage device 12. The variables of the second generation model M2 are established by training by the second training module 117 (that is, machine learning).

The second generation model M2 is a neural network (second neural network) that estimates the first data representing the deterministic component Da. The second generation model M2 is, for example, a CNN (Convolutional Neural Network) or an RNN (Recurrent Neural Network). The second generation model M2 can include additive elements such as LSTM (Long Short-Term Memory) or ATTENTION. The first data represent a sample (that is, one component value) of the deterministic component Da.

A plurality of pieces of training data including the second control data Y and the deterministic component D are supplied to the second training module 117. The second control data Y are generated by the conditioning module 112 for each partial waveform of the reference signal R, for example. The second training module 117 iteratively updates the variables of the second generation model M2 such that the loss function between the deterministic component D, which is generated by inputting the second control data Y of each piece of training data into a provisional second generation model M2, and the deterministic component D of the training data is reduced. Therefore, the second generation model M2 learns the latent relationship between the deterministic component D and the second control data Y in the plurality of pieces of training data. That is, when unknown second control data Ya are input into the trained second generation model M2, the deterministic component Da that is statistically valid on the basis of the relationship is output from the second generation model M2.

The second generation module 123 uses the trained second generation model M2 to generate a time series of the deterministic component Da corresponding to the second control data Ya. The first generation module 122 generates the stochastic component Sa(t) corresponding to the first control data Xa(t) and the plurality of deterministic components Da(t−k−1:t+m), in the same manner as in the first embodiment. The synthesis module 124 generates a sample of the sound signal V from the deterministic component Da and the stochastic component Sa, in the same manner as in the first embodiment.

In the second embodiment, the stochastic component Sa is generated in accordance with the first control data Xa, and the deterministic component Da is generated in accordance with the second control data Ya. Accordingly, the sound signal V in which both the deterministic component Da and the stochastic component Sa have high quality can be generated, in the same manner as in the first embodiment.

### C: Third Embodiment

In the second embodiment, the second generation model M2 estimates the deterministic component Da as the first data. The second generation model M2 of the third embodiment estimates the first data representing the probability density distribution of the deterministic component Da. The probability density distribution can be expressed by a probability density value corresponding to each value of the deterministic component Da, or by the mean and variance of the deterministic component Da.

The second training module 117 trains the second generation model M2 to estimate the probability density distribution of the deterministic component Da with respect to input of the second control data Ya. The training of the second generation model M2 by the second training module 117 is realized by the same procedure as the training of the first generation model M1 by the first training module 115 in the first embodiment. The second generation module 123 uses the trained second generation model M2 to generate a time series of the deterministic component Da corresponding to the second control data Ya.

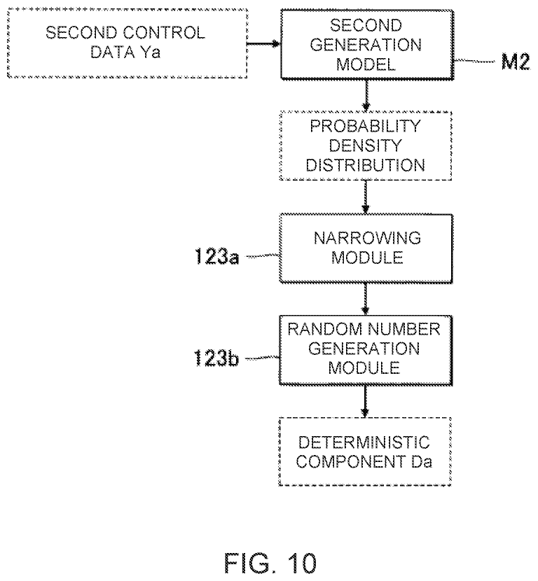

FIG. 10 is an explanatory diagram of a process by which the second generation module 123 generates the deterministic component Da. The second generation model M2 estimates a probability density function of the deterministic component Da with respect to input of the second control data Ya. The second generation module 123 includes a narrowing module 123a and a random number generation module (second random number generation module) 123b. The narrowing module 123a reduces the variance of the probability density function of the deterministic component Da. For example, when the probability density distribution is defined by a probability density value corresponding to each value of the deterministic component Da, the narrowing module 123a searches for the peak of the probability density distribution, maintains the probability density value at the aforementioned peak, and reduces the probability density value in the range outside the peak. In addition, when the probability density distribution of the deterministic component Da is defined by the mean and variance, the narrowing module 123a reduces the variance of the probability density distribution by a calculation such as multiplication by a coefficient less than 1. The random number generation module 123b generates a random number (second random number) in accordance with the narrowed probability density distribution and outputs the random number as the deterministic component Da.

The same effects as those of the second embodiment also are realized in the third embodiment. Additionally, in the third embodiment, the probability density distribution of the deterministic component Da is narrowed and thereby generates the deterministic component Da with a small noise component. Thus, according to the third embodiment, a high-quality sound signal V in which the noise component of the deterministic component Da is reduced can be generated, as compared with the second embodiment. However, the narrowing (narrowing module 123a) of the probability density distribution of the deterministic component Da can be omitted.

### D: Modification

Specific modified embodiments to be added to each of the foregoing embodiments will be illustrated below. Two or more embodiments arbitrarily selected from the following examples can be appropriately combined as long as they are not mutually contradictory.

(1) In the sound generation function of the first embodiment, the sound signal V is generated based on the information of a series of pronunciation units of the musical score data Ca, but the sound signal V can be generated in real time based on information of pronunciation units supplied from a keyboard, or the like. The generation control module 121 generates the first control data Xa for each time point based on the information of the pronunciation units that have been supplied up to that point in time. In that case, the context data X3 included in the first control data Xa basically cannot include information of future pronunciation units, but information of future pronunciation units can be predicted from past information, so as to include information of future pronunciation units. In addition, in order to reduce latency of the generated sound signal V (t), it is necessary to make the delay amount k in FIG. 3 a small value. The range of the deterministic components Da(t−k−1:t+m) that can be supplied to the first generation model M1 is thereby limited, but this is not a. major problem.

(2) The method for generating the deterministic component D is not limited to a method in which the locus of the harmonic component in the spectrum of the reference signal R is extracted, as described in the embodiments. For example, the phases of partial waveforms of a plurality of pronunciation units corresponding to the same first control data X can be aligned by spectral manipulation, or the like, and averaged, and the averaged waveform can be used as the deterministic component D. Alternatively, a pulse waveform corresponding to one period estimated from an amplitude spectrum envelope and a phase spectrum envelope in Jordi Bonada's paper “High quality voice transformations based on modeling radiated voice pulses in frequency domain” (Proc. Digital Audio Effects (DAFx). Vol. 3. 2004.) can be used as the deterministic component D.

(3) In the embodiments described above, the sound synthesizer 100 having both the preparation function and the sound generation function is exemplified, but the preparation function can be provided in a device (hereinafter referred to as “machine learning device”) that is separate from the sound synthesizer 100 having the sound generation function. The machine learning device generates the first generation model M1 by the preparation function illustrated in the embodiments described above. For example, the machine learning device is realized by a server device that can communicate with the sound synthesizer 100. The first generation model M1 trained by the machine learning device is provided in the sound synthesizer 100 and used for the generation of the sound signal V. The machine learning device can also generate, and transfer to the sound synthesizer 100, the sound generator data Q. The second generation model M2 of the second and third embodiments is also generated by the machine learning device.

(4) In the embodiments described above, the stochastic component Sa (t) is sampled from the probability density distribution generated by the first generation model M1, but the method for generating the stochastic component Sa is not limited to the example described above. For example, a generation model (for example, neural network) that simulates the above sampling process (that is, the generation process of the stochastic component Sa) can be uses for the generation of the stochastic component Sa. Specifically, as in Parallel WaveNet, a generation model that uses the first control data Xa and a random number as inputs and that outputs the component value of the stochastic component Sa is used.

(5) The sound synthesizer 100 can also be realized by a server device that communicates with a terminal device such as a mobile phone or a smartphone. For example, the sound synthesizer 100 generates the sound signal V by the sound generation function from the musical score data Ca received from the terminal device and transmits the sound signal V to the terminal device. The generation control module 121 can be provided in the terminal device. The sound synthesizer 100 receives the first control data Xa and the second control data Ya generated by the generation control module 121 of the terminal device from the terminal device, and generates, and transmits to the terminal device, the sound signal V corresponding to the first control data Xa and the second control data Ya by the sound. generation function. As can be understood from the foregoing explanation, the generation control module 121 is omitted from the sound synthesizer 100.

(6) The sound synthesizer 100 according to each of the above-described embodiments is realized by cooperation between a computer (specifically, the electronic controller 11) and a program, as is illustrated in each of the above-described embodiments. The program according to each of the above-described embodiments can be stored on a computer-readable storage medium and installed on a computer. The storage medium is, for example, a non-transitory (non-transitory) storage medium, a good example of which is an optical storage medium, such as a CD-ROM (optical disc), but can include known arbitrary storage media, such as semiconductor storage media and magnetic storage media. Non-transitory storage media include any storage medium that excludes transitory propagating signals and does not exclude volatile storage media. In addition, in a configuration in which a distribution device distributes the program via a communication network, a storage device that stores the program in the distribution device corresponds to the non-transitory storage medium.

What is claimed is:

1. A sound signal synthesis method realized by a computer, the sound signal synthesis method comprising:
generating first data representing a deterministic component of a sound signal based on second control data representing conditions of the sound signal;
generating, using a first generation model, second data representing a stochastic component of the sound signal based on the first data and first control data representing conditions of the sound signal; and
combining the deterministic component represented by the first data and the stochastic component represented by the second data and thereby generating the sound signal.

2. The sound signal synthesis method according to claim 1, wherein
the generating of the sound signal is performed by adding the deterministic component and the stochastic component.

3. The sound signal synthesis method according to claim 1, wherein
the second data represent a probability density distribution of the stochastic component,
the sound signal synthesis method further comprises generating a first random number in accordance with the probability density distribution of the stochastic component to generate the stochastic component, and
the generating of the sound signal is performed by combining the deterministic component represented by the first data and the stochastic component generated by the generating of the first random number.

4. The sound signal synthesis method according to claim 1, wherein
the first generation model is a first neural network that estimates the second data based on the first control data and the first data as inputs.

5. The sound signal synthesis method according to claim 4, wherein
at each time point in a series of time points, the second data is estimated by the first neural network based on a plurality of pieces of the first data at time points in a vicinity of the time point, and the first control data.

6. The sound signal synthesis method according to claim 1, wherein
the generating of the first data is performed by using one method of additive synthesis, wavetable synthesis, FM synthesis, modeling synthesis, and concatenative synthesis.

7. The sound signal synthesis method according to claim 1, wherein
the generating of the first data is performed by using a second neural network.

8. The sound signal synthesis method according to claim 1, wherein
the first data represent a probability density distribution of the deterministic component,
the second data represent a probability density distribution of the stochastic component,
the sound signal synthesis method further comprises
generating a first random number in accordance with the probability density distribution of the stochastic component to generate the stochastic component, and
generating a second random number in accordance with the probability density distribution of the deterministic component to generate the deterministic component, and
the generating of the sound signal is performed by combining the deterministic component generated by the generating of the second random number and the stochastic component generated by the generating of the first random number.

1. A method for training a neural network comprising:
acquiring a deterministic component of a reference signal, a stochastic component of the reference signal, and control data corresponding to the reference signal; and
training the neural network such that the neural network has ability of estimating a probability density distribution of the stochastic component in accordance with the deterministic component and the control data.

10. A sound synthesizer comprising:
an electronic controller including at least one processor, the electronic controller being configured to execute a plurality of modules including
a second generation module that generates first data representing a deterministic component of a sound signal based on second control data representing conditions of the sound signal,
a first generation module that generates, using a first generation model, second data representing a stochastic component of the sound signal based on the first data and first control data representing conditions of the sound signal, and
a synthesis module that combines the deterministic component represented by the first data and the stochastic component represented by the second data and thereby generates the sound signal.

11. The sound synthesizer according to claim 10, wherein
the synthesis module adds the deterministic component and the stochastic component to generate the sound signal.

12. The sound synthesizer according to claim 10, wherein
the first generation module includes a first random number generation module,
the second data represent a probability density distribution of the stochastic component,
the first random number generation module generates a first random number in accordance with the probability density distribution of the stochastic component to generate the stochastic component, and
the synthesis module combines the deterministic component represented by the first data and the stochastic component generated by generation of the first random number.

13. The sound synthesizer according to claim 10, wherein
the first generation model is a first neural network that estimates the second data based on the first control data and the first data as inputs.

14. The sound synthesizer according to claim 13, wherein
the first neural network estimates, at each time point in a series of time points, the second data based on a plurality of pieces of the first data at time points in a vicinity of the time point, and the first control data.

15. The sound synthesizer according to claim 10, wherein
the second generation module is one of additive synthesis, wavetable synthesis, FM synthesis, modeling synthesis, and concatenative synthesis.

16. The sound synthesizer according to claim 10, wherein
the second generation module uses a second neural network.

17. The sound synthesizer according to claim 10, wherein
the first data represent a probability density distribution of the deterministic component,
the second data represent a probability density distribution of the stochastic component,
the generation module includes
a first random number generation module that generates a first random number in accordance with the probability density distribution of the stochastic component to generate the stochastic component, and
a second random number generation module that generates a second random number in accordance with the probability density distribution of the deterministic component to generate the deterministic component, and
the synthesis module combines the deterministic component generated by generation of the second random number and the stochastic component generated by generation of the first random number.

18. The sound synthesizer according to claim 10, wherein
the electronic controller is further configured to execute a training module that acquires a deterministic component of a reference signal, a stochastic component of the reference signal, and control data corresponding to the reference signal, and train a first neural network such that the first neural network has ability of estimating a probability density distribution of the stochastic component of the reference signal in accordance with the deterministic component of the reference signal and the control data.
